(19) United States
(12) Patent Application Publication
(10) Pub. No.: US 2010/0273085 A1
(43) Pub. Date: Oct. 28, 2010

(54) Method for the Electrochemical Deposition of Catalyst Particles Onto Carbon Fibre-Containing Substrates and Apparatus Therefor

(75) Inventors: Harald Natter, Saarbrucken (DE); Vivien Keller, Saarbrucken (DE); Rolf Hempelmann, St. Ingbert (DE); Marco Lopez, Frankfurt (DE)

Correspondence Address: KALOW & SPRINGUT LLP, 488 MADISON AVENUE, 19TH FLOOR, NEW YORK, NY, 10022, US

(73) Assignee: SOLVICORE GMBH & CO. KG, Hanau-Wolfgang (DE)

(21) Appl. No.: 12/527,652

(22) PCT Filed: Feb. 15, 2008
(86) PCT No.: PCT/EP2008/001143

§ 371 Date: Jul. 6, 2010

(30) Foreign Application Priority Data
Feb. 21, 2007 (EP) 07003516.7

(51) Int. Cl. H01M 8/10; H01M 4/52; H01M 4/42; H01M 4/54; H01M 4/29; C25B 15/08

(52) U.S. Cl. 429/480; 429/483; 205/60; 205/64; 205/65; 205/66; 205/57; 205/58; 204/237

(57) ABSTRACT

The present invention describes a method and an apparatus for the electrochemical deposition of fine catalyst particles onto carbon fibre-containing substrates which have a compensating layer (“microlayer”). The method comprises the preparation of a precursor suspension containing ionomer, carbon black and metal ions. This suspension is applied to the substrate and then dried. The deposition of the catalyst particles onto the carbon fibre-containing substrate is effected by a pulsed electrochemical method in an aqueous electrolyte. The noble metal-containing catalyst particles produced by the method have particle sizes in the nanometer range. The catalyst-coated substrates are used for the production of electrodes, gas diffusion electrodes and membrane electrode units for electrochemical devices, such as fuel cells (membrane fuel cells, PEMFC, DMFC, etc.), electrolysers or electrochemical sensors.

The present invention describes a method for the electrochemical deposition of catalyst particles onto carbon fibre-containing substrates and an apparatus therefor. The substrates coated with catalyst particles are used for the production of electrodes, for example for electrochemical apparatuses, such as fuel cells, membrane fuel cells, electrolysers or electrochemical sensors. In particular, they are used for the production of gas diffusion electrodes (“GDE”) and membrane electrode units (“MEU”) for polymer electrolyte membrane fuel cells (“PEMFC”) and direct methanol fuel cells (“DMFC”).

Fuel cells convert a fuel and an oxidizing agent in separate locations from one another at two electrodes into current, heat and water. Hydrogen, a hydrogen-rich gas or methanol can serve as the fuel, and oxygen or air as the oxidizing agent. The process of energy conversion in the fuel cell is distinguished by particularly high efficiency. For this reason, fuel cells are becoming increasingly important for mobile, stationary and portable applications.

A fuel cell stack is a stackwise arrangement (“stack”) of fuel cell units. A fuel cell unit is also referred to below as fuel cell for short. It contains in each case a membrane electrode unit which is arranged between so-called bipolar plates which are also referred to as separator plates and serve for gas supply and current conduction.

The core of the membrane fuel cell is the membrane electrode unit (“MEU”). The membrane electrode unit has a sandwich-like structure and consists as a rule of five layers. For the production of this five-layer membrane electrode unit, bonding or lamination in a sandwich-like manner with the anode gas diffusion layer (anode “GDL”) on the front, the catalyst layer on the front, the cathode gas diffusion layer on the back and the catalyst layer on the back with the ionomer membrane in the middle is effected. Sealing can be effected with a suitable sealing material.

In the case of the PEMFC, the polymer electrolyte membrane consists of proton-conducting polymer materials. These materials are also referred to below as ionomers for short. A tetrafluoroethylene-fluorovinyl ether copolymer having acid functions, in particular having sulphonic acid groups, is preferably used. Such materials are sold, for example, under the trade name Nafion® (E. I. DuPont) or Flemion® (Asahi Glass Co.). However, other, in particular fluorine-free ionomer materials, such as sulphonated polyether ketones or aryl ketones or polybenzimidazoles, but also ceramic materials, can be used.

In the case of MEU production, as a rule the catalyst layers are first applied to the gas diffusion layers. The gas diffusion electrodes thus produced (“GDE”, also referred to below as “electrodes” for short) are then bonded to the front and back of an ionomer membrane. If appropriate, sealing material is then applied at the edge. However, methods in which the catalyst layer is first applied to the membrane are also known.

Conventionally, gas diffusion electrodes are produced by coating the gas diffusion layers with catalyst. Suitable carbon black-supported noble metal catalysts (e.g. of the Pt/C-type) are applied to the surface of the gas diffusion layer. As a rule, commercially available Pt/C supported catalysts or Pt/Ru/C supported catalysts having a noble metal loading of 20 to 80% by weight (based on the total weight) are used for this purpose. Two gas diffusion electrodes thus produced are then bonded (for example by lamination) to the front and back of an ionomer membrane. The catalyst particles are pressed into the membrane surface. A disadvantage thereby is the low degree of catalyst utilization. Up to 30% of the expensive Pt particles remain ineffective since they are not present in the so-called three-phase zone. Catalytic activity can arise only where (a) the ion-conducting phase, i.e. the ionomer membrane for conducting away the protons, (b) the electron-conducting phase, i.e. the electrocatalyst in electrical contact with the gas diffusion layer, and (c) the gas or liquid phase for supplying hydrogen/methanol or oxygen and for removing the water formed meet. Owing to the low degree of catalyst utilization, most membrane electrode units produced by this method have a high catalyst loading and hence high noble metal consumption.

For the commercialization of fuel cell technology, in particular in the mobile area, however, components (e.g. electrodes, membrane electrode units or stacks) having low noble metal consumption and high electrical power are required, which can be produced by means of economical methods suitable for series production.

U.S. Pat. No. 5,084,144 and U.S. Pat. No. 6,080,504 disclose electrochemical methods for the production of gas diffusion electrodes, in which an electrically conductive substrate and a counter electrode are brought into contact with an electroplating bath which contains metal ions. The deposition of the catalytically active metal is effected by short cathodic current pulses.

WO 00/56453 likewise describes a method for the electrochemical deposition of a catalyst from an electrolyte which contains the catalytically active material.

The disadvantage of the abovementioned methods is that expensive noble metal-containing electroplating baths are required. Electroplating baths are in principle nonselective; the utilization of the noble metals dissolved in the electroplating bath is very limited. Furthermore, noble metal losses occur during their working-up.

DE 197 20 688 C1 proposes a method for the production of an electrode/solid electrolyte unit in which the noble metal salt is introduced between an electrode and a solid electrolyte (i.e. an ionomer membrane) and the noble metal is then electrochemically deposited in the three-phase zone. No electroplating bath is used. However, a disadvantage of this method is that the solid electrolyte may be contaminated by ionic salt residues. Furthermore, the membrane must be continuously humidified with water during the process to maintain its conductivity. It has been found that the water partly washes out water-soluble noble metal salts from the precursor layer so that undesired noble metal losses occur, which make the method more expensive.

EP 1 307 939 B1 discloses a method for the coating of a membrane electrode unit with catalyst and an apparatus therefor. In this process, a layer which contains a metallic compound as a catalyst precursor (also referred to as “precursor layer”) is applied to an ionomer membrane and the catalyst particles are then deposited electrochemically thereon, the membrane being present in a water-vapour containing atmosphere during the electrodeposition. A disadvantage of this process is that once again a membrane is used as a solid electrolyte and said membrane can be contaminated with the water-soluble precursor compounds during the process. The method is moreover inconvenient and expensive, since the membrane has to be constantly kept in a water vapour-containing atmosphere.

M. S. Loeffler, B. GroB, H. Natter, R. Hempelmann, Th. Krajewski and J. Divisek report in Phys. Chem. Chem. Phys., 2001, 3, pages 333-336 on the electrochemical deposition of Pt nanoparticles from a precursor suspension. The deposition is effected on a disc comprising glassy carbon. This substrate serves as a model substrate and, owing to the lack of gas permeability and porosity, cannot be used for fuel cell technology.

It was therefore an object of the present invention to provide a method for the electrochemical deposition of catalyst particles onto conductive, porous substrate materials, which is economical and cheap and dispenses with the use of a membrane as a solid electrolyte. It should permit the deposition of very fine catalyst particles in the nanometer range and be suitable for continuous series production. Furthermore, it was an object of the present invention to provide an apparatus for carrying out the method.

These objects are achieved according to the present invention by providing a method according to claim 1 and the apparatus required for this purpose, according to claim 16. Preferred embodiments according to the invention are described in the respective dependent claims.

The present invention relates to a method for the electrochemical deposition of catalyst particles onto a carbon fibre-containing substrate, comprising the steps
a) application of a precursor suspension comprising ionomer, a pulverulent carbon material and at least one metal compound onto a carbon fibre-containing substrate,
b) drying of the precursor suspension,
c) electrochemical deposition of the catalyst particles onto the carbon fibre-containing substrate in an aqueous electrolyte,
   wherein the carbon fibre-containing substrate comprises a compensating layer.

The method may furthermore comprise a purification step for removing ionic impurities after the deposition of the metal particles as well as a drying step.

The invention furthermore comprises an apparatus for the electrochemical deposition of catalyst particles onto a carbon fibre-containing substrate, comprising
a) a holder (6) having seals (7) for the carbon fibre-containing substrate (1) coated with a precursor suspension,
b) a container for an aqueous electrolyte (2) above the substrate introduced into the holder,
c) electrical contacts (3), (4) and (5) for generating an electric field in the coated carbon fibre-containing substrate, and
d) means (2a) for supplying and removing the aqueous electrolyte.

The apparatus can moreover be designed so that it is suitable for the continuous coating of ribbon-like carbon fibre-containing substrates. It then furthermore has devices for the purification and/or drying of the substrate materials and optionally for the handling and transport thereof. It may furthermore comprise measuring and control devices for carrying out the electrochemical deposition, in particular, for example, galvanostats, potentiometers, etc.

In the electrochemical method according to the invention, catalyst particles are deposited from a precursor suspension onto a carbon fibre-containing substrate. The precursor suspension comprises as components an ionomer preparation, a pulverulent carbon material and at least one metal compound.

Conductive carbon blacks, furnace blacks, acetylene blacks, conductive carbon fibres, graphites, activated carbons or mixtures thereof which have a large surface area can be used as pulverulent carbon materials. Examples are Ketjenblack EC (from Akzo Corp.) or Vulcan XC72 (from Cabot Corp.).

The ionomer preparation may be used as an aqueous ionomer dispersion or alcoholic ionomer solution and is available from various manufacturers. A tetrafluoroethylene/fluorovinyl ether copolymer having acid functions, in particular having sulphonic acid groups, is preferably used. Examples are 10% by weight of Nafion® in aqueous dispersion (from DuPont, USA) or 5% by weight of Nafion® in isopropanol/water (from Aldrich Chemicals). However, other, in particular fluorine-free ionomer materials, such as sulphonated polyether ketones or aryl ketones or polybenzimidazoles and mixtures thereof can also be used as dispersions or solutions.

The noble metal salts used are water-soluble salts of the noble metals selected from the group consisting of Pt, Ru, Ag, Au, Pd, Rh, Os, Ir and mixtures thereof, in particular chlorides, nitrates, sulphates or acetates. Examples for Pt are hexa-chloroplatinic(IV) acid (H₂PtCl₆), tetrachloroplatinic(II) acid (H₂PtCl₄), platinum(II) chloride, tetramineplatinum nitrate, platinum (II) nitrate (Pt(NO₃)₂) or hexahydroxo-Pt(IV) salts. Examples of ruthenium are ruthenium(III) chloride, (RuCl₃), ruthenium(III) acetate, ruthenium=nitrosyl nitrate. Water-soluble compounds of the transition metals of the Periodic Table of the Elements, for example water-soluble salts of the metals selected from the group consisting of Fe, Co, Ni, Cu, Zn, Ti, V, Cr, W, Mo and mixtures thereof, can furthermore be used as metal salts. Examples are CoCl₂, Cr(NO₃)₂, NiCl₂ or Cu (NO₃)₂.

With the aid of the electrochemical method described here, noble metal-containing alloys, such as, for example, PtRu, PtNi, PtCr, PtCo or Pt₃Co, can be deposited from precursor suspensions which contain a plurality of metal salts.

The suspension may contain further additives, such as, for example, wetting agents, dispersing agents, binders, thickening agents, stabilizers or antioxidants, and may be tailor-made for the respective application method. Suspensions for application by means of screen printing are, for example, in the form of a paste. For the preparation of the suspension, the components are thoroughly mixed. Conventional dispersing methods (such as, for example, ultrasonic agitation, dissolvers, stirrers, roll mills, bead mills, etc.) are suitable for this purpose.

The precursor suspension is preferably applied to conductive, carbon fibre-containing substrates. Suitable materials are carbon fibre papers or carbon fibre fleece (so-called “non-woven materials”), as commercially available from the companies Toray (Japan), Textron (USA), ETEK (USA) or SGL-Carbon (Germany). The carbon fibre-containing substrates may furthermore be graphitized or carbonized. The carbon fibre-containing substrate (also referred to as “gas diffusion layer”) may be hydrophobized and furthermore may have proportions of woven fabric. It can be used as a single sheet or as roll-good for continuous methods.

It has been found that particularly fine catalyst particles can be produced by the method according to the invention. For the deposition of these particularly fine catalyst particles (i.e. particles having a mean diameter of ≦10 nm, preferably 5 nm), use of substrates which have a fine fibre structure, such as, for example, carbon fibre fleece or carbon fibre papers (i.e. “non-woven materials”) has proved useful. The thickness of the carbon fibres in these substrates is in the range from 0.5 to 50 μm, preferably in the range from 0.5 to 20 μm. The fine fibres of these carbon fibre substrates produce regions of very high current density, e.g. at the ends, tips and edges of the fibres. After the application of the precursor suspension, these regions come into contact with the metal compounds in the precursor layer. Since, in principle, the particle size of the particles to be deposited decreases with increasing current density, it is possible in this way to deposit very small catalyst particles. Furthermore, the formation of particle agglomerates is avoided.

For the production of the particularly fine catalyst particles (i.e. particles ≦10 nm, preferably ≦5 nm), the use of carbon fibre-containing substrates comprising a so-called compensating layer (“microlayer” or “microporous layer”) has furthermore proved useful. This compensating layer is microporous, electrically conductive and typically contains a mixture of conductive carbon black and hydrophobic polymer, for example PTFE. It is, as a rule, applied to one side (i.e. to the side facing the membrane after assembly) of the substrate and has a very fine pore structure. Regions of very high current density, which lead to the deposition of very small particles, can in turn form in the fine pores of the compensating layer.

The air permeability (according to GURLEY) can be used as a measure of the pore structure of the substrate. The most suitable carbon fibre-containing substrates have an air permeability (according to GURLEY) of <20 cm³/(cm² sec), preferably <10 cm³/(cm² sec) and particularly preferably <5 cm³/(cm² sec) (determined using a standard GURLEY densometer; e.g. model 4118 or 4340, e.g. according to ISO 5636-5). Substrates having air permeability values above 20 cm³/(cm² sec) generally have no compensating layer and/or are less suitable owing to their coarse pore structure.

The layer thickness of the compensating layer should be in the range from 5 to 100 μm, preferably in the range from 10 to 50 μm. Best results are obtained with substrates which have a compensating layer of about 20 μm thickness.

Examples of particularly suitable substrates are the Sigracet GDL substrates of type “C” (for example GDL 30 BC, or GDL 31 BC (from SGL Technologies GmbH, Meitingen, Germany)) or the substrate ETEK LT 1200-N (PEMEAS Fuel Cell Technologies, Somerset, N.J., USA).

If the precursor suspension is applied to the compensating layer of the carbon fibre-containing substrate, excessively deep penetration of the suspension into the open pore structure of the carbon fibre-containing substrate can be prevented. The catalyst particles can thus be deposited in a narrow, limited region on the surface of the substrate.

The application of the precursor suspension to the compensating layer of the carbon fibre-containing substrate can be effected by known methods, such as, for example, spraying, dipping, doctor-blading, brushing, offset printing, screen printing or stencil printing. The “airbrush” method is preferably used, the viscosity of the suspension being adjusted to be appropriately low. The substrate is fixed in a frame for better stability and the application should be effected slowly and uniformly so that the layer dries to the touch during the spray process itself. In the case of strongly hydrophobic substrates, the suspension can be applied in a plurality of steps, intermediate drying being effected between the spray processes. The suspension penetrates slightly into the compensating layer after the application. The adhesion of the precursor suspension to the substrate surface is improved thereby.

Before the electrodeposition, the applied precursor suspension is dried. It forms a precursor layer thereby. This can be effected by conventional drying methods, for example in a drying oven, by means of a vacuum, by circulating air or infrared, optionally also in continuous methods. The drying process can be carried out under an inert gas atmosphere (e.g. nitrogen, argon or vacuum) at room temperature or at elevated temperatures (up to 130° C. maximum), and the drying times are between a few minutes and a few hours, depending on the method. The layer thickness of the precursor layer or the amount of the precursor suspension should be chosen so that between 0.01 and 5 mg of metal/cm², preferably between 0.1 and 4 mg of metal/cm², are deposited. The thickness of the precursor layer is typically in the range from 5 to 100 μm, preferably in the range from 5 to 50 μm, after the drying.

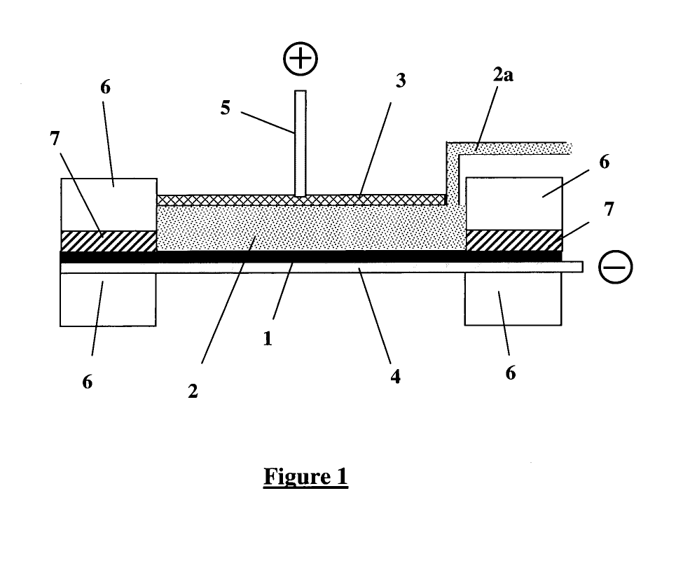

After the drying, the metal ions in the dried precursor suspension are reduced. For this purpose, the coated conductive substrate is introduced into an apparatus which has a holder for the substrate and has means for producing and adjusting a liquid electrolyte above the substrate introduced into the holder. The electrolyte is present in a container above the substrate, which is formed by a Teflon frame and optionally seals. A schematic diagram of the apparatus for the electrochemical deposition of the catalyst particles is shown in FIG. 1.

The carbon fibre-containing substrate (1) is applied to a cathodic contact plate (4). With the aid of a holder frame comprising plastic (6), preferably comprising Teflon, and seals (7), a container for the aqueous electrolyte (2) is created above the substrate. The container has a feed line or discharge line (2a) for transporting the aqueous electrolyte during the process. The anodic contacting is provided above the electrolyte with the aid of the plate (3) and the feed line (5). For the anodic contacting (“counter electrode”), it is possible to use, in addition to glassy carbon, for example a platinum net, which, through its dimensioning, predetermines the electrochemically active area on the conductive substrate.

Diluted acids, preferably diluted sulphuric acid or perchloric acid, in concentrations of 0.5 to 2 mol/l may be used as aqueous electrolyte. The spacing between the two electrodes should be as small and constant as possible in order to avoid variations in current density. The spacing is preferably in the range from 1 mm to 20 mm. The amount of electrolyte should be kept as low as possible and its amount as constant as possible. The apparatus can moreover be designed so that it is suitable for the continuous coating of ribbon-like conductive materials. It then furthermore has devices for the cleaning and/or drying of the substrate materials and optionally for the handling and transport thereof.

The parameters of the method for the electrochemical deposition with pulsed electrodeposition (PED) are known to the person skilled in the art. Details in this context appear in the abovementioned publication by M. S. Loeffler, B. GroB, H. Natter, R. Hempelmann, Th. Krajewski and J. Divisek (Phys. Chem. Chem. Phys., 2001, 3, pages 333-336). The pulsed method is preferably carried out in the galvanostatic mode (i.e. at constant current) for reasons relating to apparatus technology. However, it can also be operated in the potentiostatic mode (i.e. at constant voltage).

The following settings have proved to be advantageous for galvanostatic operation. The pulsed current densities (Iₚ) are preferably in the range from 10 to 5000 mA/cm². For maintaining the current and for ensuring the particle size, a voltage in the range from 0.1 to 20 V, preferably in the range from 5 to 20 V, is required. The pulse width is in the range from 0.5 to 10 milliseconds (“tₒₙ time”) and the pulse pauses (“t_{off} time”) are 0.1 to 10 milliseconds. The pulse frequency is preferably in the range from 500 to 1000 Hertz. The deposition times are, as a rule, between 1 and 20 minutes, preferably at room temperature.

In particular, it should be ensured that a pulsed voltage is applied before the introduction of the electrolyte. As soon as the electrolyte has been introduced, the current circuit closes and the pulsed electrodeposition begins immediately. It has been found that premature dissolving of the metal salts out of the precursor layer is prevented thereby and the metal salts thus cannot diffuse into the electrolyte. The damage to the electrolyte is prevented and metal losses are avoided thereby. Furthermore, the deposition of very fine catalyst particles in the nanometer range is achieved, since the process of nucleation is favoured over the process of particle growth (e.g. by metal deposition from the electrolyte) during the formation of the catalyst particles.

For the aqueous cleaning of the substrates after the pulsed deposition, demineralized water (“DI water”) has proved useful. By thorough washing with warm demineralized water, electrolyte residues, salt residues or other impurities can easily be removed. The purification effect can optionally be improved by ultrasonic means.

The drying of the cleaned substrates can be carried out in conventional drying apparatuses (e.g. drying oven, circulating air, hot air, IR). In the case of automated series production, the cleaning and drying steps can be integrated into a continuous plant.

The catalyst-coated substrates produced according to the invention can be processed as electrodes (preferably gas diffusion electrodes) with ionomer membranes in the known methods (e.g. lamination) to give multilayer membrane electrode units.

The method according to the invention permits the production of electrodes which, with a low noble metal loading, produce high electric power in fuel cell stacks and hence help to achieve low noble metal consumption.

The method is very suitable for the continuous fabrication of membrane electrode units (MEUs). The associated apparatus is distinguished by a simple design and easy scaleability with regard to continuous series production.

### Experimental Section

To carry out the pulsed electrochemical method, a programmable pulse generator (type HAMEG BM 8130, from Hameg Elektronik, Germany), with which the pulse width and pulsed current density are set, is used. The voltage source used is a galvanostat from KEPCO Electronic Inc. (Illinois, USA).

The particle sizes are determined by means of TEM (high resolution transmission electron spectroscopy). The crystallinity and the metallic composition of the particles are determined by means of XRD (X-ray diffractometry, powder samples).

The invention is explained in more detail in the following examples. The examples serve merely for explaining the invention and are not intended to limit the scope of protection.

### EXAMPLES

### Example 1

### Coating with Catalyst Particles (Pt₃Co; Loading 0.3 mg/cm²)

Carbon Fibre Substrate with Compensating Layer

For coating a carbon fibre substrate having an area of 100 cm², a precursor suspension which consists of the following components:

```
  2.5 ml of Nafion ® dispersion (10% by weight in water; from DuPont)
16.0 ml of isopropanol
10.0 mg of conductive carbon black (Ketjenblack EC 300 J, from Akzo)
90.0 mg of hexachloroplatinic acid (H₂PtCl₆•H₂O; solid, from Chempur)
  8.7 mg of cobalt chloride (CoCl₂, solid, from Chempur, Karlsruhe)
is prepared.
```

The individual components are weighed in and are dispersed in a 50 ml vessel with the aid of ultrasonic agitation (35 kHz) for 10 min. The suspension is then applied by the airbrush method to a carbon fibre substrate of the type SIGRACET 30 BC (from SGL Carbon Group, Meitingen, Germany). Material: graphitized carbon fibre fleece, hydrophobized with 5% by weight of PTFE, thickness 330 μm, with compensating layer (thickness about 20 μm), air permeability according to GURLEY: 0.5 cm³/(cm² sec). The thickness of the carbon fibres is in the region of 10 μm (determined by means of SEM/TEM).

For the airbrush method, a spray pressure of 2.5 bar is used and nitrogen serves as spray gas. The drying is performed at 40° C. for 30 min in a drying oven under a nitrogen atmosphere. The metal ions in the precursor layer are then electrochemically reduced by a pulsed method (sulphuric acid electrolyte, concentration 2 mol/l; duration of deposition 15 min at room temperature).

### Pulse Parameters for Deposition:

| | | |
|---|---|---|
| tₒₙ: | 1 | msec |
| t_{off}: | 0.5 | msec |
| Iₘ: | 1000 | mA/cm² |
| Frequency: | 666.67 | Hz |
| Voltage (amplitude): | 15 | V |

The substrate is washed thoroughly with DI water after the deposition in order to remove electrolyte and chloride ions. After the drying (40° C., circulation drying oven), a carbon fibre substrate coated with catalyst particles and having the following properties is obtained:

| | |
|---|---|
| Catalyst loading: | 0.3 mg/cm² of Pt₃Co |
| Mean particle size (TEM): | 2 nm |
| X-ray structure (XRD): | nanocrystalline alloyed particles |

### Example 2

### Coating with Catalyst Particles (Pt₃Co; Loading 1 mg/cm²)

Carbon Fibre Substrate with Compensating Layer

For coating a carbon fibre substrate having an area of 100 cm², a precursor suspension which consists of the following components:

```
  2.5 ml of Nafion ® solution (10% in water; from DuPont)
  16.0 ml of isopropanol
  10.0 mg of conductive carbon black (Ketjenblack EC 300 J, from Akzo)
180.0 mg of hexachloroplatinic acid (H₂PtCl₆•H₂O; solid, from Chempur)
  26.0 mg of cobalt chloride (CoCl₂, solid, from Chempur) is prepared.
```

The suspension is prepared as described in Example 1 and applied to a carbon fibre substrate of the type SIGRACET 30 BC (from SGL Carbon Group, Meitingen) by the airbrush method (for properties, cf. Example 1). The pulse parameters for the electrochemical deposition are given in Example 1. After washing and drying, a carbon fibre substrate coated with catalyst particles and having the following properties is obtained:

| | |
|---|---|
| Catalyst loading: | 1 mg/cm² of Pt₃Co |
| Mean particle size (TEM): | 2 nm |
| X-ray structure (XRD): | nanocrystalline alloyed particles |

### Example 3

### Coating with Catalyst Particles (Pt; Loading 0.3 mg/cm²)

Carbon Fibre Substrate with Compensating Layer

For coating a carbon fibre substrate having an area of 100 cm², a precursor suspension which consists of the following components:

2.5 ml of Nafion ® dispersion (10% by weight in water; from DuPont)
16.0 ml of isopropanol
10.0 mg of conductive carbon black (Ketjenblack EC 300 J, from Akzo)
64.0 mg of hexachloroplatinic acid (H₂PtCl₆•H₂O; solid, from Chempur)
is prepared.

The individual constituents are weighed in and are dispersed in a 50 ml vessel with the aid of ultrasonic agitation. The suspension is applied, as described in Example 1, by the airbrush method to a carbon fibre substrate of the type SIGRACET 30 BC (from SGL Carbon Group, Meitingen, for properties, cf. Example 1). The drying is effected at 40° C. for 30 min in a drying oven. Platinum in the precursor layer is then electro-chemically deposited (parameters as in Example 1). The cleaning and drying of the substrate is conducted as stated in Example 1. A carbon fibre substrate coated with Pt catalyst particles and having the following properties is obtained:

| | |
|---|---|
| Catalyst loading: | 0.3 mg of Pt/cm² |
| Mean particle size (TEM): | 2 nm |
| X-ray structure (XRD): | nanocrystalline particles |

### Example 4

### Coating with Catalyst Particles (Pt₃Co; Loading 0.3 mg/cm²)

Carbon Fibre Substrate with Compensating Layer

For coating a carbon fibre substrate having an area of 100 cm², a precursor suspension is prepared according to Example 1.

The suspension is applied by the airbrush method to a carbon fibre substrate of the type ETEK LT 1200-N (from PEMEAS, ETEK Division, Somerset, N.J., 08873 USA). Material: nonwoven carbon fibre fleece, water-repellent, with compensating layer (thickness about 25 μm); air permeability according to GURLEY: 0.5 cm³/(cm² sec).

For the airbrush method, a spray pressure of 2.5 bar is used and nitrogen serves as spray gas. The drying is effected at 40° C. for 30 min in a drying oven under a nitrogen atmosphere. Metal ions in the precursor layer are then electrochemically reduced by a pulsed method (parameters as stated in Example 1). After the cleaning and drying (40° C., circulation drying oven) a carbon fibre substrate coated with catalyst particles and having the following properties is obtained:

| | |
|---|---|
| Catalyst loading: | 0.3 mg/cm² of Pt₃Co |
| Mean particle size (TEM): | 2-5 nm |
| X-ray structure (XRD): | nanocrystalline alloyed particles |

### Comparative Example (CE 1)

### Coating with Catalyst Particles (Pt₃Co; Loading 0.3 mg/cm²)

Carbon Fibre Substrate without Compensating Layer

For coating a carbon fibre substrate having an area of 100 cm², a precursor suspension is prepared according to Example 1. The suspension is applied to a carbon fibre substrate of the type SIGRACET 30 BA (from SGL Carbon Group, Meitingen) by the airbrush method. The carbon fibre substrate is a graphitized carbon fibre fleece with a hydrophobization made with 5% by weight of PTFE, and the thickness is 310 μm. The substrate has no compensating layer and the air permeability according to GURLEY is 40 cm³/(cm² sec).

The drying of the suspension is effected at 40° C. for 30 min in a drying oven under nitrogen. The metals in the precursor layer are then electrochemically deposited (parameters as in Example 1). A carbon fibre substrate coated with Pt₃Co catalyst particles and having the following properties is obtained:

| | |
|---|---|
| Catalyst loading: | 0.3 mg of Pt₃Co/cm² |
| Mean particle size (TEM): | 20-30 nm |
| X-ray structure (XRD): | nanocrystalline alloyed particles |

As shown by this comparative example, carbon fibre substrates without compensating layer are not suitable for depositing very fine catalyst particles.

1. Method for the electrochemical deposition of catalyst particles onto a carbon fibre-containing substrate, comprising the steps:
a) application of a precursor suspension comprising ionomer, a pulverulent carbon material and at least one metal compound onto a carbon fibre-containing substrate,
b) drying of the precursor suspension,
c) electrochemical deposition of the catalyst particles onto the carbon fibre-containing substrate in an aqueous electrolyte;
wherein the carbon fibre-containing substrate comprises a compensating layer.

2. Method according to claim 1, wherein the carbon fibre-containing substrate is a nonwoven carbon fibre material such as carbon fibre fleece or carbon fibre paper.

3. Method according to claim 1, wherein the precursor suspension contains as metal compound salts of the noble metals selected from the group consisting of platinum (Pt), ruthenium (Ru), rhodium (Rh), osmium (Os), iridium (Ir), silver (Ag), palladium (Pd), gold (Au) and mixtures thereof.

4. Method according to claim 1, wherein the precursor suspension contains metal compounds of the metals selected from the group consisting of Fe, Co, Ni, Cu, Zn, Ti, V, Cr, W, Mo and mixtures thereof.

5. Method according to claim 1, wherein the precursor suspension contains additives such as wetting agents, dispersing agents, binders, thickening agents, stabilizers or antioxidants.

6. Method according to claim 1, wherein the ionomer comprises proton-conducting polymers, such as, for example, tetrafluoroethylen/fluorovinyl-ether copolymers with sulphonic acid groups.

7. Method according to claim 1, wherein the pulverulent carbon material comprises high surface area conductive carbon blacks, furnace blacks, acetylene blacks, conductive carbon fibres, graphites, activated carbons or mixtures thereof.

8. Method according to claim 1, wherein the application of the suspension to the carbon fibre-containing substrate is performed by methods such as spraying, dipping, doctor-blading, brushing, offset printing, screen printing or stencil printing.

9. Method according to claim 1, wherein the aqueous electrolyte comprises diluted sulphuric acid or diluted perchloric acid or mixtures thereof.

10. Method according to claim 1, wherein the electrochemical deposition is performed in a pulsed method.

11. Method according to claim 10, wherein the pulsed method is conducted in the galvanostatic mode.

12. Method according to claim 10, wherein the pulsed method is conducted at a voltage in the range from 0.1 to 20V.

13. Method according to claim 10, wherein the pulsed method is conducted at a pulsed current density (Iₙ) in the range from 10 to 5000 mA/cm².

14. Method according to claim 1, wherein the drying of the precursor suspension is carried out at temperatures in the range from 20 to 130° C.

15. Method according to claim 1, furthermore comprising a cleaning and/or a drying step of the coated carbon fibre substrate after deposition of the catalyst particles.

16. Apparatus for the electrochemical deposition of catalyst particles onto a carbon fibre-containing substrate, comprising
a) a holder having seals for the carbon fibre-containing substrate coated with a precursor suspension,
b) a container for an aqueous electrolyte above the substrate introduced into the holder,
c) electrical contacts for generating an electric field in the coated carbon fibre-containing substrate and
d) means for supplying and removing the aqueous electrolyte.

17. Apparatus according to claim 16, furthermore comprising a device for applying the precursor suspension to the carbon fibre-containing substrate.

18. Apparatus according to claim 16, furthermore comprising a device for drying the coated carbon fibre-containing substrate after application of the precursor suspension.

19. Apparatus according to claim 16, furthermore comprising a device for cleaning and drying of the coated carbon fibre-containing substrate after deposition of the catalyst particles.

20. Apparatus according to claim 16, furthermore comprising devices for continuous operation with ribbon-like substrate materials.

21. A gas diffusion electrode for electrochemical devices, such as membrane fuel cells, PEMFC, DMFC, electrolysers or electrochemical sensors, the electrode comprising a catalyst-coated substrate made by the method of claim 1.

22. A membrane electrode unit for polymer electrolyte membrane fuel cells, the unit comprising a catalyst-coated substrate made by the method of claim 1.
